(19) United States
(12) Patent Application Publication
(10) Pub. No.: US 2017/0140031 A1
(43) Pub. Date: May 18, 2017

(54) CLIENT SERVICE PIPE CONFIGURATION

(71) Applicant: InvestCloud Inc, Beverly Hills, CA (US)

(72) Inventors: Julian Bowden, London (GB); John W. Wise, West Hollywood, CA (US); Vicent Sos-Munoz, Beverly Hills, CA (US)

(73) Assignee: InvestCloud Inc, Beverly Hills, CA (US)

(21) Appl. No.: 14/942,114

(22) Filed: Nov. 16, 2015

(51) Int. Cl. G06F 17/30; G06Q 30/00

(52) U.S. Cl. CPC G06F 17/30604; G06F 17/30867; G06F 17/30554; G06Q 30/01

(57) ABSTRACT

A system comprises a processor that receives a set of unstructured data and a structured object, generates a link to the structured object, and composes a client service pipe comprising the set of unstructured data and the link to the structured object. The set of unstructured data is visible within the client service pipe, the link to the structured object being hidden within the client service pipe.

### BACKGROUND

1. Field

This disclosure generally relates to the field of computing devices. More particularly, the disclosure relates to messages that are communicated between computing devices.

2. General Background

Customer relation management (“CRM”) systems are examples of forms-based systems that automate and synchronize interactions between an entity and a customer. CRM may also be utilized to provide such synchronization and automation between the entity and another entity, e.g., business to business (“B2B”) interactions. The CRM systems are typically implemented in contact centers of the entity so that the entity may codify interactions between the entity and the customer/additional entity to optimize the level of service provided by the entity to the customer/additional entity to maximize profit.

Current CRM systems are typically forms-based. In other words, users of current CRM systems often input data via various electronic forms. Such a form of data input is simply not intuitive to most users. For example, many users do not enter all of the data into the forms correctly. Without all of the necessary data inputted into the forms, the CRM system cannot operate in an optimal manner. Further, many users enter the data into a variety of different forms that are difficult for those users to subsequently locate.

The difficulty of the forms-based approach to CRM systems is that the structure of the forms is often generated by a user that would input data quite differently than other users. Therefore, the form structure of a particular user is then imposed onto other users that would possibly generate quite different form structures. As a result, a CRM system is typically only utilized by an entity on a temporary basis until that CRM system is abandoned so that another forms-based CRM system can be utilized. Such iterations have led to inefficiencies in resource allocation. Thus, the forms-based approach for CRM systems is inefficient.

### SUMMARY

In one aspect of the disclosure, a system is provided. The system comprises a processor that receives a set of unstructured data and a structured object, generates a link to the structured object, and composes a client service pipe comprising the set of unstructured data and the link to the structured object. The set of unstructured data is visible within the client service pipe, the link to the structured object being hidden within the client service pipe.

Further, more than one structured object may be utilized. In addition, more than one link may be utilized. Alternatively, the link may be visible rather than hidden within the client service pipe.

In another aspect of the disclosure, a computer program product is provided. The computer program product comprises a computer useable storage device having a computer readable program. The computer readable program when executed on a computer causes the computer to receive a set of unstructured data and a structured object. Further, the computer readable program when executed on the computer causes the computer to generate a link to the structured object. In addition, the computer readable program when executed on the computer causes the computer to compose a client service pipe comprising the set of unstructured data and the link to the structured object. The set of unstructured data is visible within the client service pipe, the link to the structured object being hidden within the client service pipe.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a client service pipe.

FIG. 2A illustrates a client service pipe configuration.

FIG. 2B illustrates an alternative client service pipe configuration.

FIG. 2C illustrates another alternative client service pipe configuration.

FIG. 3 illustrates a display screen of a display device that displays a set of search results generated by the search engine illustrated in FIGS. 2A, 2B, and 2C.

FIG. 4 illustrates an interface that may be utilized to generate or search for client service pipes.

FIG. 5 illustrates a hashtag menu configuration.

FIG. 6 illustrates a process that may be utilized to generate the client service pipe illustrated in FIG. 1.

FIG. 7 illustrates a block diagram of a system that generates the client service pipe illustrated in FIG. 1.

### DETAILED DESCRIPTION

A client service pipe configuration may be utilized to provide forms-based services, e.g., CRM, content management service (“CMS”), and/or other communication-based services. The client service pipe configuration allows a computing platform and/or one or more users to generate client service pipes. A client service pipe is a data structure that includes a visible set of unstructured text and a hidden link to an object, e.g., a form, news item, URL, document, image, video, etc.

Various identifiers may be utilized within the client service pipe to identify or define the particular client service pipe. For example, a hashtag may be utilized. A search may then be performed for that hashtag to obtain the client service pipe and other client service pipes that also include that hashtag. The search may be filtered by utilizing additional hashtags to narrow the search.

Alternatively, a user may automatically receive client service pipes based upon a subscription to certain identifiers, e.g., hashtags, rather than via performing a search. The user can establish a profile, notification conditions, etc. so that the client service pipe platform automatically sends the user client service pipes that include the particular identifier corresponding to a notification condition.

The identifiers of the client service pipe configuration may also be utilized to establish access permissions to the hidden portions of the client service pipes. For example, various hashtags indicating particular users, types of users, groups, etc. may be included in a client service pipe to limit access to the hidden portions of the client service pipes.

In one embodiment, users may directly enter client service pipes through an Application Programming Interface (“API”) to the client service pipe configuration through a computing device, e.g., smartphone, tablet device, smartwatch, laptop computer, personal computer (“PC”), etc. In another embodiment, the client service pipe configuration may automatically generate client service pipes. For instance, the client service pipe configuration may automatically generate client service pipes based upon the occurrence of the lack of occurrence of certain events. Such events may be predefined by the client service pipe configuration or established by users, e.g., via user preferences.

The client pipe service configuration allows computing systems and/or users to generate messages in a format independent manner. Therefore, the client pipe service configuration does not have to modify or adapt to any particular format. As a result, the client pipe service configuration improves the functioning of a computing system by providing structured objects to users in a manner that is unstructured.

In contrast with previous configurations that do not allow for the linkage of unstructured data to structured objects, the client pipe service configuration allows users to generate messages in a user customizable manner that may be linked to structured objects. Further, the client pipe service configuration allows data to be captured and subsequently linked. In other words, a system or user may generate a visible portion of a client service pipe, e.g., a message, and subsequently generate the hidden portion of the client service pipe, e.g., a link to a structured object.

An inferred structured object may also be constructed from one or more clues in the hashtags. For example, a hashtag may be defined to refer to a useful object that a host computer does not natively understand. Such an object may be a factory pipe entry about what products the factory may have at various times, further information about the factory facility, e.g., address, dates of meetings, and proprietors, etc. An inferred structured object of the factory and the events taking place at the factory may be built up over time.

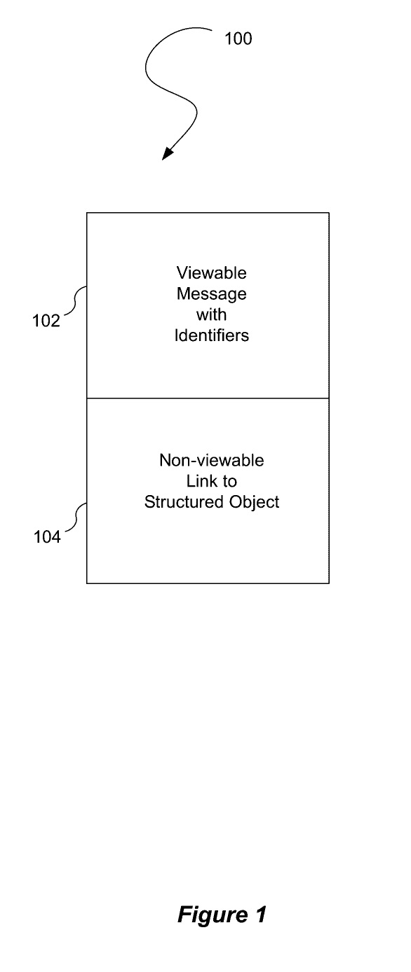

FIG. 1 illustrates a client service pipe 100. The client service pipe 100 comprises a viewable message 102 and a non-viewable link 104. The viewable message may comprise one or more identifiers, e.g., hashtags, that identify the client service pipe 100. For instance, the hashtags may be utilized to identify the client service pipe 100 via topic, person, client, business, category, genre, event, communication, date, time, etc. Therefore, different users can post different viewable messages 102 with various identifiers according to an unstructured format. For instance, a user can input a message with various hashtags throughout a set of text and post that message as the viewable message 102.

The client service pipe 100 also comprises a non-viewable link 104. The Non-viewable link 104 is a link to a structured object such as a form, image, video, audio, document, news item, etc. The user can select the structured object to which the client service pipe 100 is linked so that another user can select an indicium in the viewable message 102 and automatically be redirected to the structured object referenced by the link. For instance, a user posting a client service pipe 100 may want other users to fill out a particular form. The user that performs the posting prepares a set of unstructured text as the viewable message 102 according to the preference of that particular user. The user then selects the form to which the client service pipe 100 is to be linked. For example, a user can select an electronic file containing a form. As another example, the user can select a hashtag indicating a preset link that is inserted as the non-viewable link 104. A computing device, e.g., server computer, smartphone, tablet device, smartwatch, laptop computer, personal computer (“PC”), etc., then links the viewable message 102 to the form by inserting an address, e.g., uniform resource locator (“URL”), as the non-viewable link 104. As a result, the user posting the viewable message need not be concerned with any type of structured format for posting the client service pipe 100. Further, the details of the non-viewable link 104 may be hidden so that users viewing the posted client service pipe 100 may concentrate on the content of the viewable message 102 prepared by the user.

The client service pipe 100 allows a user to capture information quickly without attention to structure. Further, the client service pipe 100 allows that user to add more information into the client service pipe 100. In addition, the client service pipe 100 allows that user to edit information already in the client service pipe 100.

Further, the client service pipe 100 is not limited to user generate messages. For example, a system may generate a client service pipe 100 on an event driven basis. For instance, a system may offer a subscription service to which a plurality of users are subscribed. The system then generates client service pipes 100 based upon the occurrence of certain events. The system may then send notifications to the subscribers that the client service pipes 100 have been generated. As examples, news events, financial transactions, inbound communications, outbound communications, user activities, security issues, CRM, CMS, notes, etc., may be events that are utilized to generate client service pipes 100. The communications may be telephone calls, e-mails, text messages, etc.

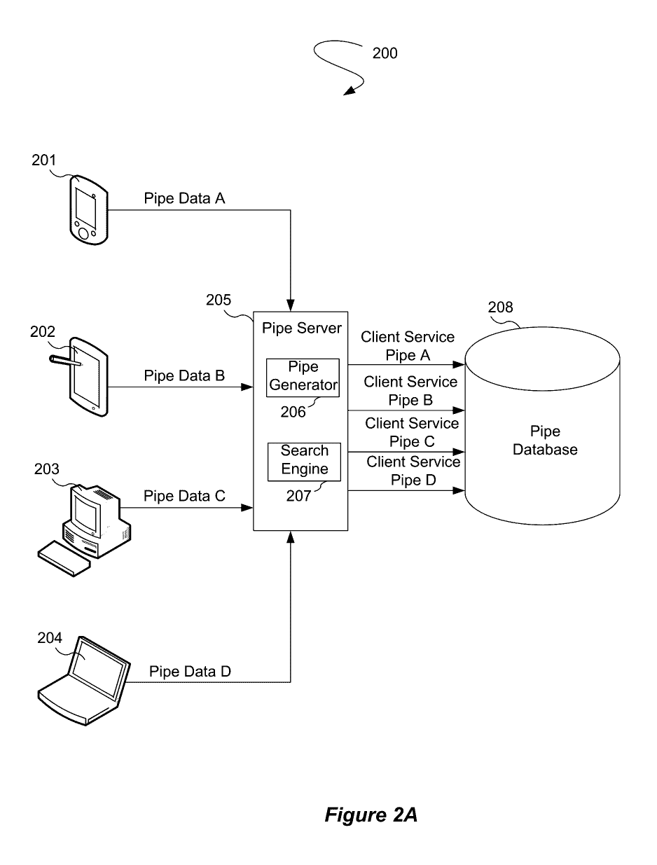

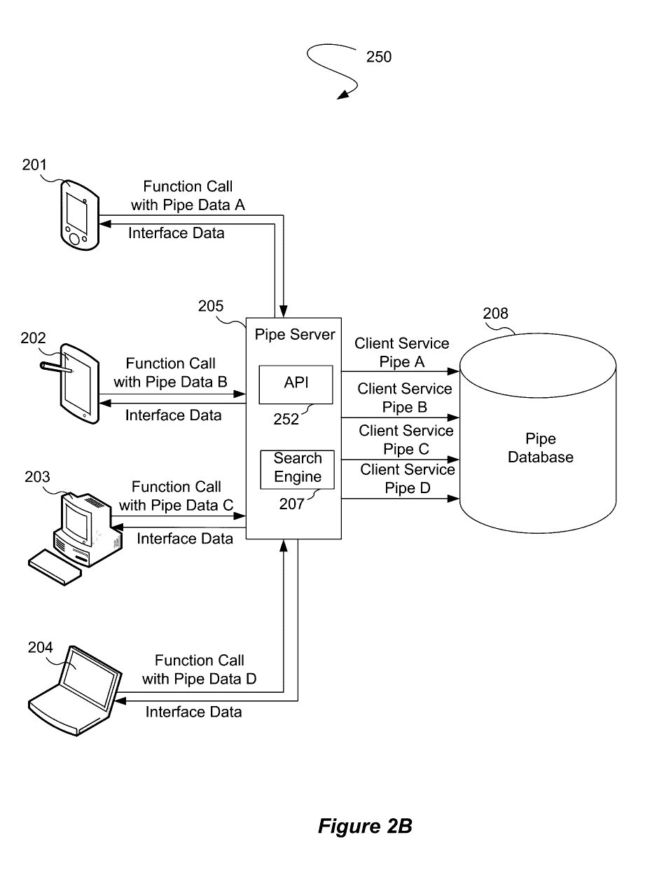

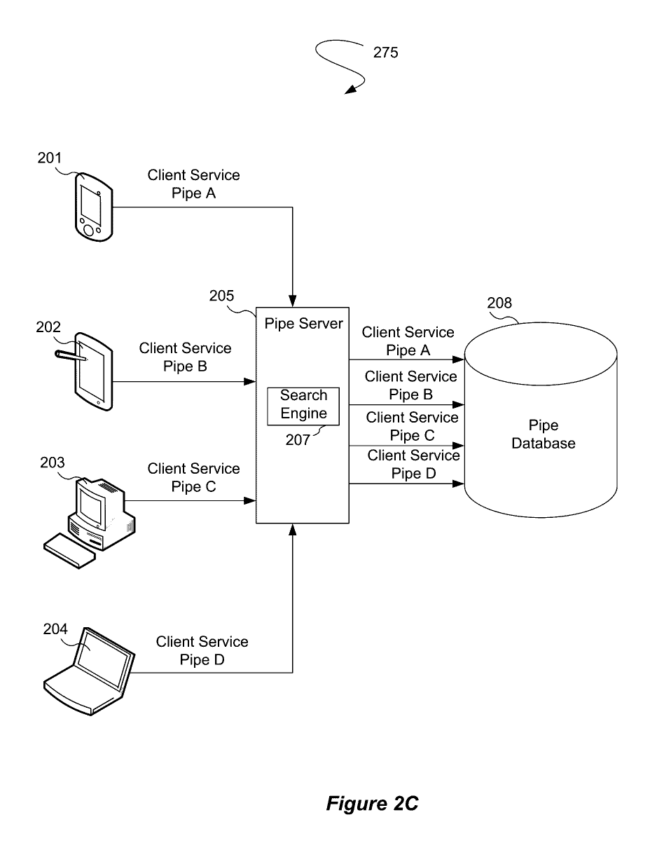

FIG. 2A illustrates a client service pipe configuration 200. The client service pipe configuration 200 has a plurality of computing devices, e.g., smartphone 201, tablet device 202, PC 203, and laptop computer 204 from which a variety of users can generate pipe data such as viewable messages 102 as illustrated in FIG. 1. Each of the devices 201, 202, 203, and 204 may then send the corresponding pipe data to a pipe server 205. The pipe server 205 utilizes a pipe generator 206 to generate a client service pipe 100 corresponding to each set of pipe data received by inserting a non-viewable link 104 as illustrated in FIG. 1 with the viewable message 102 into the client service pipe 100. For example, a client service pipe A corresponding to the pipe data received from the smartphone 201 may be generated by the pipe generator 206, a client service pipe B corresponding to the pipe data received from the tablet device 202 may be generated by the pipe generator 206, a client service pipe C 203 may be generated by the pipe generator 206, and a client service pipe D 204 may be generated by the pipe generator 206. The pipe server 205 may then store the client service pipes A, B, C, and D in a pipe database 206 for retrieval based upon searches of client service pipes.

As an example, the pipe data received from the devices 201, 202, 203, and 204 may all have a common identifier, e.g., hashtag. Each of the client service pipes A, B, C, and D would then be generated by the pipe server 205 to have viewable message portions 102 that display the common identifier. A search may then subsequently be performed by the pipe server 205 utilizing a search engine 207 at the request of a user through a computing device interacting with the pipe server 205 or automatically through a computing device interacting with the pipe server 205 based upon the common identifier that would retrieve all of the client service pipes A, B, C, and D. Client service pipes 100 that do not have the common identifier that is the basis for the search would not be retrieved. As an example, the pipe data received from the devices 201, 202, 203, and 204 may each be different messages that all have #customer as a hashtag intended by users or systems to be displayed as viewable message portions 102 of the client service pipes A, B, C, and D. If a user searches the pipe database 205 for the hashtag #customer, the user would obtain search results that include the client service pipes A, B, C, and D.

The client server 205 may instead generated client service pipes 100 based on data received from each of the devices 201, 202, 203, and 204. For instance, each of the devices 201, 202, 203, and 204 may send a communication, e.g., e-mail, SMS text message, etc., to the pipe server 205 with the message and locations of the structured object for the client service pipe 100 so that the pipe server 205 can generate the client service pipe 100. An RSS feed may be utilized instead to provide syndicated data directly to the pipe server 205 for client service pipe generation.

FIG. 2B illustrates an alternative client service pipe configuration 250. The client service pipe configuration 250 allows the devices 201, 202, 203, and 204 to access an application programming interface (“API”) 252 stored on the pipe server 205 to obtain interface data, e.g., functions, protocols, etc. The devices 201, 202, 203, and 204 then send function calls with the corresponding pipe data to the API 252 through the pipe server 205 to generate the client service pipes 100.

FIG. 2C illustrates another alternative client service pipe configuration 275. The client service pipe configuration 275 allows the devices 201, 202, 203, and 204 to generate the client service pipes 100 rather than the devices 201, 202, 203, and 204 having to request that the pipe server 205 generates the client service pipes 100. For instance, each of the devices 201, 202, 203, and 204 may download an application from the pipe server 205 that allows each of the devices 201, 202, 203, and 204 to generate client service pipes 100.

Although the client service pipe 100 allows a user to link unstructured data to a structured object, such linkage is not required. For example, some client service pipes 100 may have non-viewable links whereas other client service pipes 100 may not have non-viewable links.

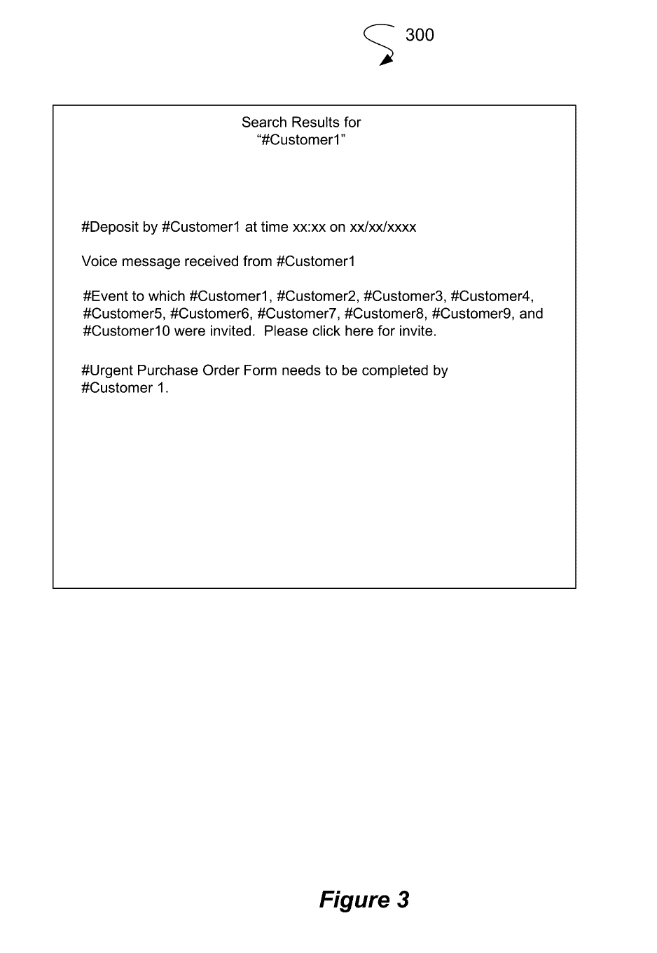

FIG. 3 illustrates a display screen 300 of a display device that displays a set of search results generated by the search engine 207 illustrated in FIGS. 2A, 2B, and 2C. For example, a user may have utilized a computing device to interact with the pipe server 205 to request a search by the search engine 207 of the pipe database 208 for all client service pipes 100 that have the hashtag #Customer1. As the client service pipes A, B, C, and D all contained the hashtag #Customer1, the search engine 207 outputs the client service pipes A, B, C, and D as a set of search results for display by the display device. In other words, the user is able to search various types of messages that reference #Customer1.

For instance, the client service pipe A may be a deposit message that is generated by the pipe server 205 to provide a notification that Customer1 performed a deposit on a certain date and time. The user viewing the search results may select an indicium, e.g., a highlighted word, in the client service pipe A to be redirected to a structured object, e.g., a deposit slip. Further, the client service pipe B may be a voice message that was received from Customer 1. The user viewing the search results may select an indicium, e.g., a highlighted word, in the client service pipe B to be redirected to a structured object, e.g., an audio file to hear the voice message. In addition, the client service pipe C may be an event note that includes a list of customers, e.g., Customers 1-10, that were invited to an event. The user viewing the search results may then select an indicium within the message to view an invitation to the event. The client service pipe D may be a request for a form that needs to be completed by Customer 1. An indicium may be selected to be redirected to the form for input of data into the form.

Identifiers other than the searched identifier may appear in the client service pipes. For example, the hashtag #Urgent may also appear. A user searching based upon the hashtag #Urgent may obtain search results for client service pipes that have that identifier.

Further, searches are not limited to the exact search term. For example, preferences may be established to allow for variability in searching, i.e., similar words or different words with similar meanings to the searched word may appear in search results.

In addition, searches may be performed by accessing the search engine 207 through a graphical user interface (“GUI”) of a computing device. Searches may instead be performed by sending a text message with identifiers in the search that indicate search terms.

The client service pipe 100 may also be utilized to manage access permissions for the structured object to which the non-viewable link 104 is directed. For example, identifiers for certain users or groups of users may be indicated by an identifier, e.g., #officers. Such identifiers restrict access to the structured object to those users or groups of users identified by the identifiers. In one embodiment, the identifier indicating a permission may be placed in the viewable message 102 of the client service pipe 100. In another embodiment, the identifier indicating the permission may be placed as a hidden portion of the client service pipe 100 with the non-viewable link 104.

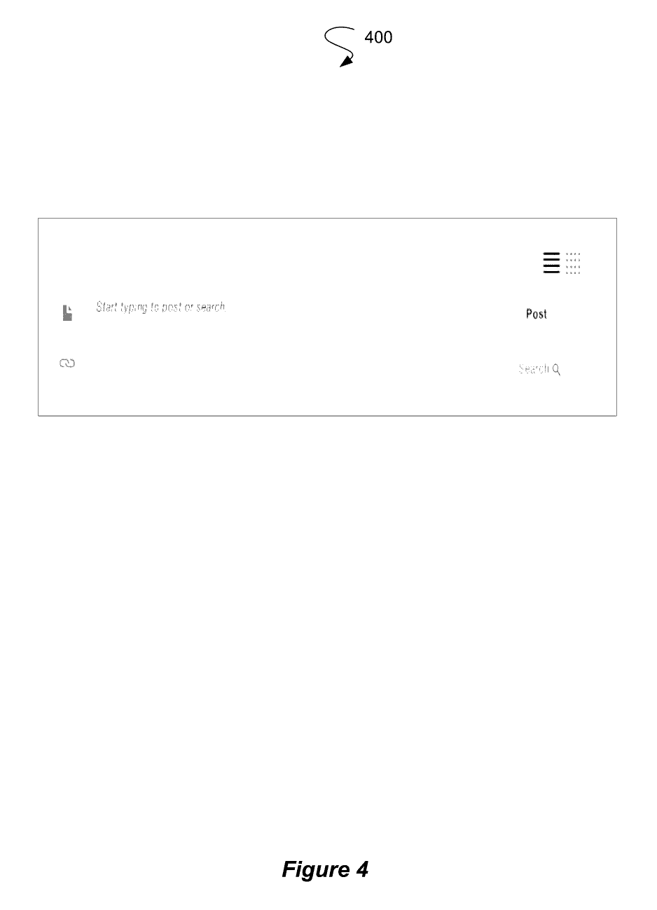

FIG. 4 illustrates an interface 400 that may be utilized to generate or search for client service pipes 100. A user can type a message with identifiers, e.g., hashtags, that is the viewable message 102 of the client service pipe 100 so that a client service pipe 100 can be generated by the pipe server 205 or by a device 201, 202, 203, or 204. Further, the user can upload structured objects by through an attachment button. The user can instead type an identifier to search for client service pipes 100 that contain the identifier and/or similar identifiers. The search results may be displayed by the display screen 300 illustrated in FIG. 3.

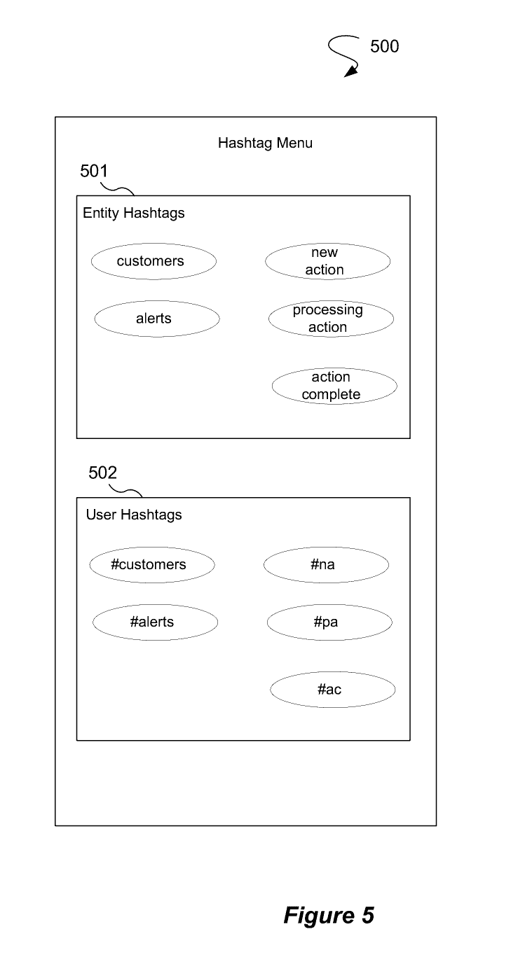

FIG. 5 illustrates a hashtag menu configuration 500. The hashtag menu configuration 500 allows a user to select various hashtags for entry into the interface 400 illustrated in FIG. 4. The user can select a button from a set of entity hashtags 501 or a set of user hashtags 502. After selection of the button, the corresponding hashtag will then be entered into the interface 400 for the user. Therefore, the hashtag menu configuration 500 allows for faster entry by the user of hashtags into the interface 400 without the user having to manually type the hashtags into the interface 400.

The set of entity hashtags 501 may be the standard set of hashtags utilized by an organization. For example, the pipe server 205 may monitor display the most commonly utilized hashtags as the set of entity hashtags 501. The pipe server 205 may instead display a set of entity hashtags 501 as determined by the organization.

The set of user hashtags 502 is a set of hashtags utilized by the particular user of the hashtag menu configuration 500. The pipe server 205 may modify the set of entity hashtags 501 based upon common use of particular hashtags. As an alternative, users may start modifying use of user hashtags 502 based upon the set of entity hashtags 501.

As an example, the set of user hashtags 502 may have synonyms or abbreviations for the set of entity hashtags 501, e.g., #na for #new action. The set of user hashtags 502 may also have some identical terms to the set of entity hashtags 501, e.g., #customers.

In one embodiment, an artificial intelligence (“AI”) system or a recommendation system is utilized to assist a user in entering an identifier, e.g., a hashtag. For example, the AI system or the recommendation system may provide a hint to the user to assist the user in entering a hashtag. For instance, the AI system or the recommendation system may detect an unknown hashtag entered by the user either manually or from the set of user hashtags 502. The AI system or the recommendation system may suggest another hashtag to the user so that the user can renter the more accurate hashtag. The AI system or the recommendation system may obtain the hashtag from a hashtag library of hashtags. In other words, the identifier is identified to conform with an identifier having the same or a similar meaning to that intended by the user from a library of commonly used identifiers. Such adaptation may be performed on a customized basis for a particular entity as a particular identifier may have different meanings for different entities.

The client service pipes 100 illustrated in FIG. 1 may also be managed through a life cycle management system. Each client service pipe 100 may have a start and an end date. For example, a client service pipe 100 may be for a future event that is not accessible until a certain date. After the end date, the client service pipe 100 is not accessible.

Various items may be entered into a client service pipe 100. For example, a note on the data may be inputted. Further, the data itself with field names and associated values may be inputted into the client service pipe 100. In addition, a structured object such as a screenshot, image, audio file, etc. may also be inputted into the client service pipe 100. A link such as a URL may also be inputted into the client service pipe 100.

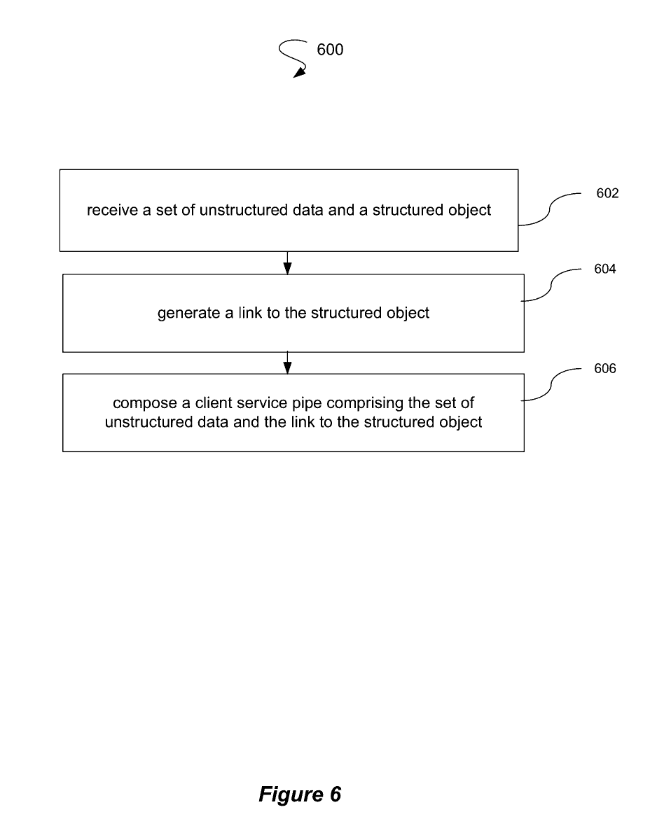

FIG. 6 illustrates a process 600 that may be utilized to generate the client service pipe 100 illustrated in FIG. 1. At a process block 602, the process 600 receives a set of unstructured data and a structured object. Further, at a process block 604, the process 600 generates a link to the structured object. In addition, at a process block 606, the process 600 composes a client service pipe comprising the set of unstructured data and the link to the structured object. The set of unstructured data is visible within the client service pipe, the link to the structured object being hidden within the client service pipe.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code, intermediary language or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above. The messaging protocol configurations described herein are device-independent as they may be utilized to send and receive messages for a variety of types of computing devices such as personal computers, laptops, tablet devices, smartphones, kiosks, set top boxes, etc.

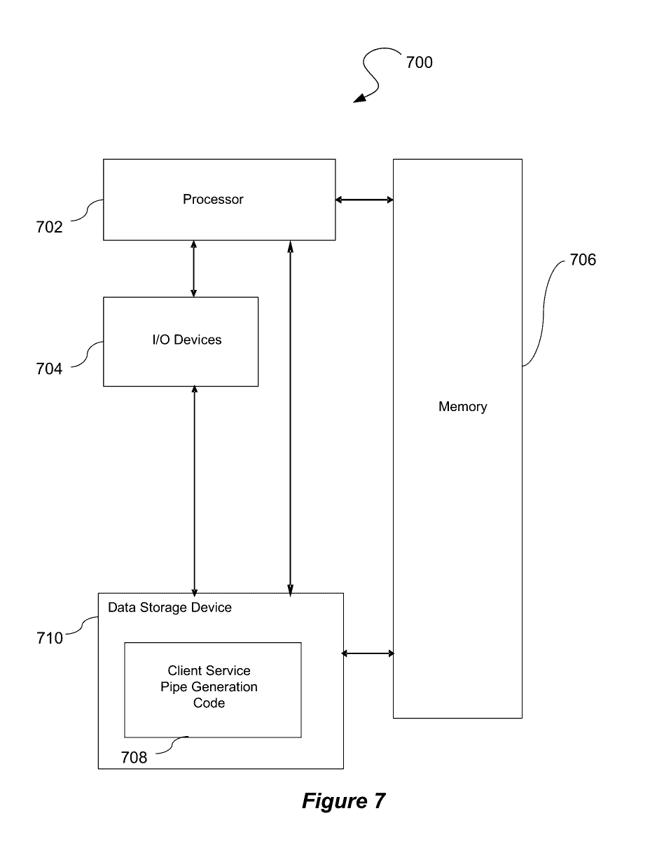

FIG. 7 illustrates a block diagram of a system 700 that generates the client service pipe 100 illustrated in FIG. 1. In one embodiment, the station or system 700 is implemented utilizing a general purpose computer or any other hardware equivalents. Thus, the station or system 700 comprises a processor 702, a memory 706, e.g., random access memory (“RAM”) and/or read only memory (ROM), client service pipe generation code 708, a data storage device 710 that stores the client service pipe generation code 708, and various input/output devices 704, e.g., audio/video outputs, audio/video inputs, a receiver, a transmitter, a speaker, a display, an image capturing sensor, a clock, an output port, a user input device, etc.

The client service pipe generation code 708 may be represented by one or more software applications or a combination of software and hardware where the software is loaded from a storage medium such as a storage device, e.g., a magnetic or optical drive, diskette, or non-volatile memory and operated by the processor 702 in the memory 706 of the computer. As such, the client service pipe generation code 708 and associated data structures of the present disclosure may be stored on a computer readable medium such as a computer readable storage device, e.g., RAM memory, magnetic or optical drive, diskette, etc.

The system 700 may be utilized to implement any of the configurations. In one embodiment, the client service pipe generation code 708 is stored by the processor 702.

It is understood that the processes, systems, apparatuses, and computer program products described herein may also be applied in other types of processes, systems, apparatuses, and computer program products. Those skilled in the art will appreciate that the various adaptations and modifications of the embodiments of the processes, systems, apparatuses, and computer program products described herein may be configured without departing from the scope and spirit of the present processes and systems. Therefore, it is to be understood that, within the scope of the appended claims, the present processes, systems, apparatuses, and computer program products may be practiced other than as specifically described herein.

We claim:

1. A system comprising:
a processor that receives a set of unstructured data and a structured object, generates a link to the structured object, and composes a client service pipe comprising the set of unstructured data and the link to the structured object, the set of unstructured data being visible within the client service pipe, the link to the structured object being hidden within the client service pipe.

2. The system of claim 1, wherein the set of unstructured data comprises an identifier that identifies the set of unstructured data.

3. The system of claim 2, wherein the identifier is a hashtag.

4. The system of claim 3, wherein the processor outputs a set of search results comprising the client service pipe based upon a search for the hashtag.

5. The system of claim 3, wherein the processor outputs a notification based upon a condition corresponding to the hashtag being met.

6. The system of claim 1, wherein the processor receives an input requesting access to the structured object and provides the access to the structured object via the link.

7. The system of claim 6, wherein the input is based upon a selection of an indicium corresponding to the link, the indicium being visible within the set of unstructured data.

8. The system of claim 1, wherein the set of unstructured data comprises a message containing text.

9. The system of claim 1, wherein the structured object is selected from the group consisting of: a video, an image, a document, and a form.

10. The system of claim 1, wherein the processor restricts access to the structured object based upon a permission indicated by an identifier in the client service pipe.

11. The system of claim 1, wherein the processor selects a set of similar indicators to an indicator that defines the client service pipe and outputs the client service pipe as a search result based upon a search for a similar indicator in the set of similar indicators.

12. The system of claim 1, wherein the processor selects a set of similar indicators to an indicator that defines the client service pipe and outputs a notification that includes the client service pipe upon a condition corresponding to a similar indicator in the set of similar indicators being met.

13. A computer program product comprising a computer useable storage device having a computer readable program, wherein the computer readable program when executed on a computer causes the computer to:
receive a set of unstructured data and a structured object;
generate a link to the structured object; and
compose a client service pipe comprising the set of unstructured data and the link to the structured object, the set of unstructured data being visible within the client service pipe, the link to the structured object being hidden within the client service pipe.

14. The computer program product of claim 13, wherein the set of unstructured data comprises an identifier that identifies the set of unstructured data.

15. The computer program product of claim 14, wherein the identifier is a hashtag.

16. The computer program product of claim 15, wherein the computer is further caused to output a set of search results comprising the client service pipe based upon a search for the hashtag.

17. The computer program product of claim 15, wherein the computer is further caused to output a notification based upon a condition corresponding to the hashtag being met.

18. The computer program product of claim 13, wherein the computer is further caused to receive an input requesting access to the structured object and provides the access to the structured object via the link.

19. The computer program product of claim 18, wherein the input is based upon a selection of an indicium corresponding to the link, the indicium being visible within the set of unstructured data.

20. The computer program product of claim 13, wherein the computer is further caused to restrict access to the structured object based upon a permission indicated by an identifier in the client service pipe.
